(19) United States
(12) Patent Application Publication
(10) Pub. No.: US 2010/0299284 A1
(43) Pub. Date: Nov. 25, 2010

(54) METHODS AND SYSTEMS FOR PROVIDING UTILITY USAGE AND PRICING INFORMATION TO A CUSTOMER

(76) Inventors: Dario Gristina, Kent Lakes, NY (US); Yaesr Khalifa, Kent Lakes, NY (US)

Correspondence Address: LEVISOHN, BERGER , LLP, 11 BROADWAY , Suite 615, NEW YORK, NY, 10004, US

(21) Appl. No.: 12/779,344

(22) Filed: May 13, 2010

Related U.S. Application Data
(63) Continuation of application No. 11/013,108, filed on Dec. 15, 2004.
(60) Provisional application No. 61/177,681, filed on May 13, 2009.

(51) Int. Cl. G06Q 50/00; G06T 11/20

(52) U.S. Cl. 705/412; 345/440

(57) ABSTRACT

Methods and systems are provided for providing electricity usage information to a customer using a market-based pricing plan. According to various embodiments of the invention, this usage information includes real-time information on the current level of electricity being consumed as well as the current rate and/or cost level of that usage. By providing this and other information to a customer through a single, convenient device that is easy to read, customers of electricity are more likely to change consumption habits based on pricing information FM Radio Broadcast Digital System provides real-time pricing information directly to the consumer via the airwaves

### RELATED APPLICATIONS

This application is a continuation of prior patent application Ser. No. 11/013,108, which was filed on Dec. 15, 2004 and Provisional Patent Application Ser. No. 61/177,681, which was filed on May 13, 2009 and which applications are incorporated herein by reference.

### FIELD OF THE INVENTION

The present invention relates to the field of utility usage monitoring and reporting. More particularly, this invention relates to monitoring a customer's usage of a utility, such as electricity, and providing the customer with real-time data concerning the amount of past and/or current usage and the pricing level in effect during the past and/or present usage.

### BACKGROUND OF THE INVENTION

Utility rates, such as electricity rates, often vary among different customers based on several factors, including the type of customer (e.g., commercial, industrial, or residential), the kind of contract that is in place, and the customer's consumption or usage needs. In the case of electricity consumption, a customer's bill is generally computed on the basis of the customer's electricity pricing level (rate), the level of electricity consumption by the customer (usage), and other charges (e.g., taxes and other surcharges).

While electricity is a real-time commodity, and while pricing among different customers has been known to vary substantially, electricity has generally not been treated as a real-time commodity in the past when it comes to pricing. In particular, for a vast majority of customers, electricity has been charged based on a fixed pricing schedule (as if it was a stored commodity, such as oil, water, or natural gas). In other words, in the past, most customers of electricity have paid a constant price for all electricity usage. This has generally been due to a lack of adequate metering technologies, coupled with political, financial and other reasons.

More recently, with metering and related communications technologies becoming more widely available, and with changes being undertaken by various regulatory bodies, national attention has been drawn to the many potential benefits of charging for electricity in a manner more closely associated with its real-time nature. In particular, there has been a push for the use of market-based pricing plans in the energy market as a way to appropriately charge electricity costs to customers, taking into account generation peak loading times and times when generators are running primarily unloaded. It is widely believed that a widespread use of pricing variations in this manner will not only promote conservation, but also increase the reliability of the electric grid, with a variety of benefits including an increase in the country's national security.

In market-based pricing plans, which recognize that the wholesale price of power changes at various times of day, week, and year (e.g., prices increase dramatically during hot summer afternoons when the use of air conditioners is common), customers are charged for the usage of electricity at variable rates that at least partially depend on the level of demand for electricity at the time of usage. Two such pricing plans include time-of-use and real-time pricing plans.

In time-of-use pricing plans, customers pay the most for power during weekday hours, and the least overnight and on weekends, for example. In these plans, there are generally three different levels of pricing (peak, off-peak, and mid-peak pricing levels), although additional levels have also been used. With real-time pricing plans, the price charged to consumers for a utility varies as its own price changes. Thus, using this type of plan, the price for energy can change for a customer on a daily, hourly, or even minute basis, for example. In both of these types of pricing plans, data registered by electric meters is used by applying different billing rates for different times, where the cost of electrical energy consumption or usage is determined as a function of the particular times during which the electrical energy was consumed.

A major benefit of market-based pricing plans is the ability to provide incentive to customers, and in particular to residential customers, to reduce electricity usage during periods of high demand (e.g., peak periods) in favor of usage during periods of low demand (e.g., off-peak periods). As a result, these pricing plans have the potential to provoke a more constant level of demand for electricity across seasons and portions of the day. In turn, there is the potential for prices for electricity to be pushed lower as fewer power generating plants and power-delivery facilities (which all require a great deal of expense to build) are required to meet periodic spikes in demand.

While market-based pricing plans have the potential to create a more constant level of demand for electricity, the effectiveness of these plans is limited as a result of the inefficient manner in which pricing and usage information is provided to customers. For example, the vast majority of customers are not provided information in real-time regarding the level of pricing that is in effect for electricity usage. Moreover, even when pricing information is readily available, and customers could be provided with timely feedback concerning their current usage of electricity, in the past, there has been no simple, low cost means or device available to customers that would allow them to quickly and visibly appreciate the level of consumption in their home or facility versus the real-time cost of electricity. Among other things, such a device would assist customers in making real-time decisions regarding whether electricity usage should be increased or decreased based on the current pricing level.

Accordingly, it is desirable to provide new methods and systems for providing electricity usage and pricing information or data to a customer that pays for the use of electricity using a market-based pricing plan. One advantage of the present invention is the ability to employ the long standing RADIO BROADCAST DATA SYSTEM (RBDS) which was created in 1988. That system allows for data transport protocols, such as data packs, to be transmitted. Such data transmission, commonly used to display such things as titles of songs, performs and the like which appear on an FM radio's display may also be employed for other data purposes The present invention uniquely combines the RBDS and specifically designed open data packets which are then committed by conventional FM transmission stations to be received by the consumer's power box so that real-time energy pricing may be easily obtained without significant or major changing of home wiring systems.

### SUMMARY OF THE INVENTION

Methods and systems are provided for providing electricity usage and pricing information or data to a customer that pays for the use of electricity using a market-based pricing plan. In one embodiment, the invention provides a method for providing electricity usage and pricing information that includes receiving electricity usage data at a display device, displaying, using the received usage data, electricity usage information by the display device for identifying real-time usage of electricity, receiving electricity pricing data at the display device utilizing Radio Broadcast Digital Systems RBDS among other communication alternatives, and displaying, using the received pricing data, electricity pricing information by the display device for identifying real-time pricing of electricity. The main advantage of utilizing RBDS over all other communication systems, is that it does not need any networking infrastructure apart from any FM radio signal that exists everywhere.

In another embodiment, the invention provides a system for providing electricity usage and pricing information that includes at least one electricity meter capable of measuring and storing information relating to the usage of electricity, and a display device for displaying both electricity usage information for identifying real-time usage of electricity and electricity pricing information for identifying real-time pricing of electricity, where the displayed electricity usage information is based on received electricity usage data and the displayed electricity pricing information is based on received electricity pricing data.

In yet another embodiment, the invention provides a system for providing electricity usage and pricing information that includes means for measuring and storing information relating to the usage of electricity, and means for displaying on a single display device both electricity usage information for identifying real-time usage of electricity and electricity pricing information for identifying real-time pricing of electricity, where the displayed electricity usage information is based on received electricity usage data and the displayed electricity pricing information is based on received electricity pricing data.

According to another embodiment, the invention provides a display device for displaying both electricity usage and pricing information, where the display device receives real-time electricity usage data and real-time electricity pricing data, the display device displays usage information for identifying real-time usage of electricity, and the display device displays pricing information for identifying real-time pricing of electricity.

### BRIEF DESCRIPTION OF THE DRAWINGS

Additional embodiments of the invention, its nature and various advantages, will be more apparent upon consideration of the following detailed description, taken in conjunction with the accompanying drawings, in which like reference characters refer to like parts throughout, and in which:

FIG. 1 is a simplified illustration of a usage display device having a liquid crystal display (LCD) that is used for providing an electricity customer electricity usage and pricing information in accordance with at least one embodiment of the present invention;

FIG. 2 shows a more detailed view of the LCD shown in FIG. 1 when the device is being used to provide electricity pricing information in accordance with at least one embodiment of the present invention;

FIG. 3 shows another more detailed view of the LCD shown in FIG. 1 when the device is being used to provide electricity pricing information in accordance with at least one embodiment of the present invention;

FIG. 4 shows a more detailed view of the LCD shown in FIG. 1 when the device is being used to provide electricity usage information in accordance with at least one embodiment of the present invention;

FIG. 5 shows another more detailed view of the LCD shown in FIG. 1 when the device is being used to provide electricity usage information in accordance with at least one embodiment of the present invention;

FIG. 6 shows a more detailed view of the LCD shown in FIG. 1 when the device is being used to provide electricity cost information in accordance with at least one embodiment of the present invention;

FIG. 7 shows another more detailed view of the LCD shown in FIG. 1 when the device is being used to provide electricity cost information in accordance with at least one embodiment of the present invention;

FIG. 8 shows a more detailed view of the LCD shown in FIG. 1 when the device is being used to simultaneously provide a combination of electricity pricing, usage, and cost information in accordance with at least one embodiment of the present invention;

FIG. 9 shows another more detailed view of the LCD shown in FIG. 1 when the device is being used to simultaneously provide a combination of electricity pricing, usage, and cost information in accordance with at least one embodiment of the present invention;

FIG. 10 shows yet another more detailed view of the LCD shown in FIG. 1 when the device is being used to simultaneously provide a combination of electricity pricing, usage, and cost information in accordance with at least one embodiment of the present invention;

FIG. 11 shows a more detailed view of the LCD shown in FIG. 1 when the device is being used to provide additional electricity usage information in connection with the usage information shown in FIG. 10 in accordance with at least one embodiment of the present invention;

FIG. 12 shows a more detailed view of the LCD shown in FIG. 1 when the device is being used to provide electricity pricing information for the past twelve months in accordance with at least one embodiment of the present invention;

FIG. 13 shows a more detailed view of the LCD shown in FIG. 1 when the device is being used to provide electricity pricing information for the past week in accordance with at least one embodiment of the present invention;

FIG. 14 shows a more detailed view of the LCD shown in FIG. 1 when the device is being used to provide electricity usage information for the past week in accordance with at least one embodiment of the present invention;

FIG. 15 shows a more detailed view of the LCD shown in FIG. 1 when the device is being used to provide electricity cost information for the past week in accordance with at least one embodiment of the present invention;

FIG. 16 shows a more detailed view of the LCD shown in FIG. 1 when the device is being used to simultaneously provide a combination of electricity usage and cost information for the past week in accordance with at least one embodiment of the present invention;

FIG. 17 shows a more detailed view of the LCD shown in FIG. 1 when the device is being used to provide past pricing and post software update information in accordance with at least one embodiment of the present invention; and

FIG. 18 is a simplified illustration of a computer having remote access to the device shown in FIG. 1 in accordance with at least one embodiment of the present invention.

FIG. 19 is a sample of a Radio Broadcast Digital System RBDS message format. Each RBDS Group consists of four blocks for a total of 104 bits. Each block carries 16 bits of data and 10 bits of error checking bits for a total of 26 bits per block. The number of groups needed depends on the size of data to be transmitted

FIG. 20 Shows a Universal Header Packet for the Open Data Application ODA. The header packet identifies the mode, style, and packet size information.

FIG. 21 Shows a sample of the RBDS packet proposed in this invention. It is a flexible packet that takes into account multiple pricing standard zones as well as special rates that could apply to select customers.

### DETAILED DESCRIPTION OF THE INVENTION

Methods and systems are described below for providing electricity usage and pricing (rate) information or data to a customer that pays for the use of electricity using a market-based pricing plan. It will be understood that certain features which are well known in the art are not described in great detail in order to avoid complication of the subject matter of the present invention.

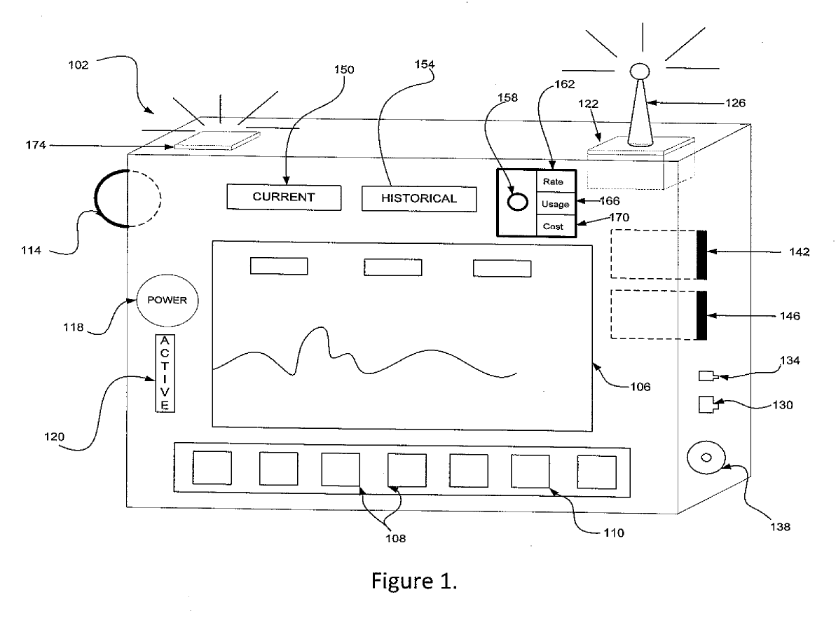

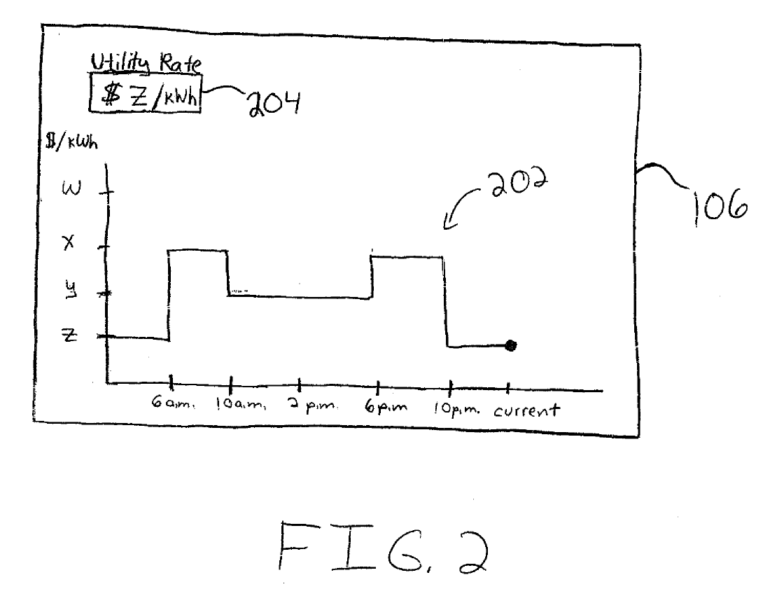

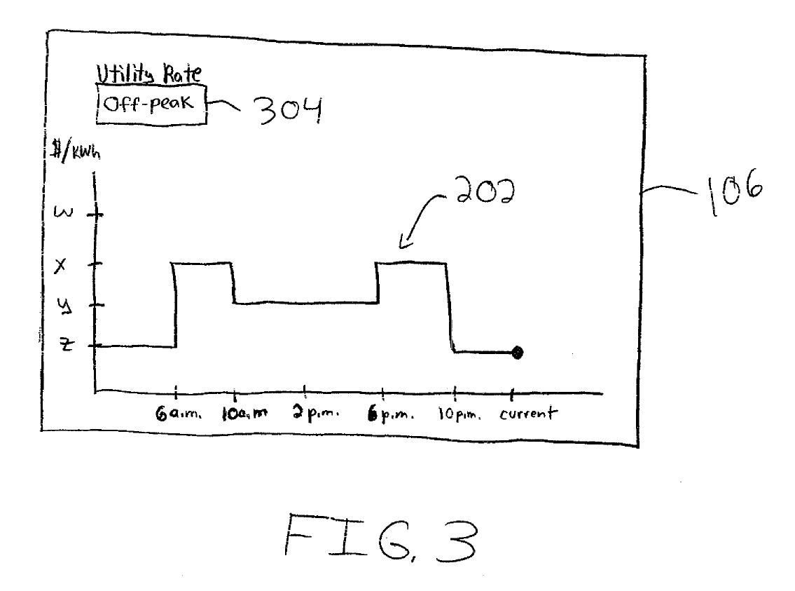

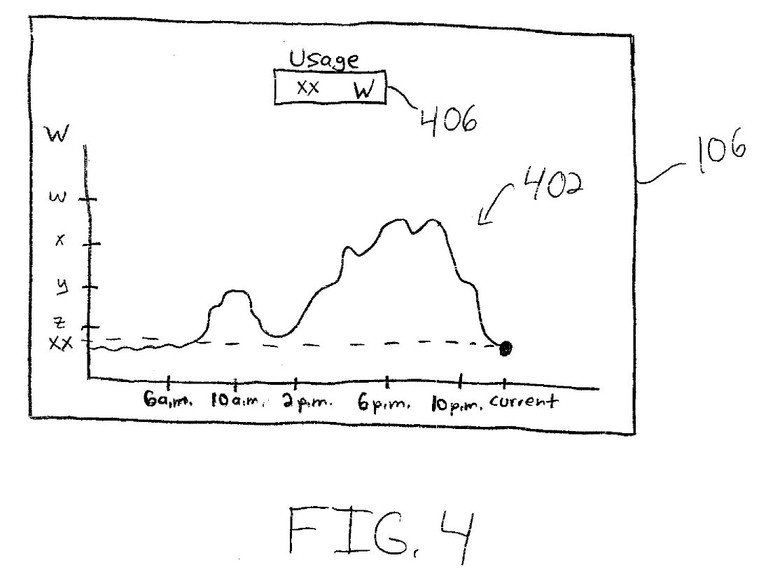

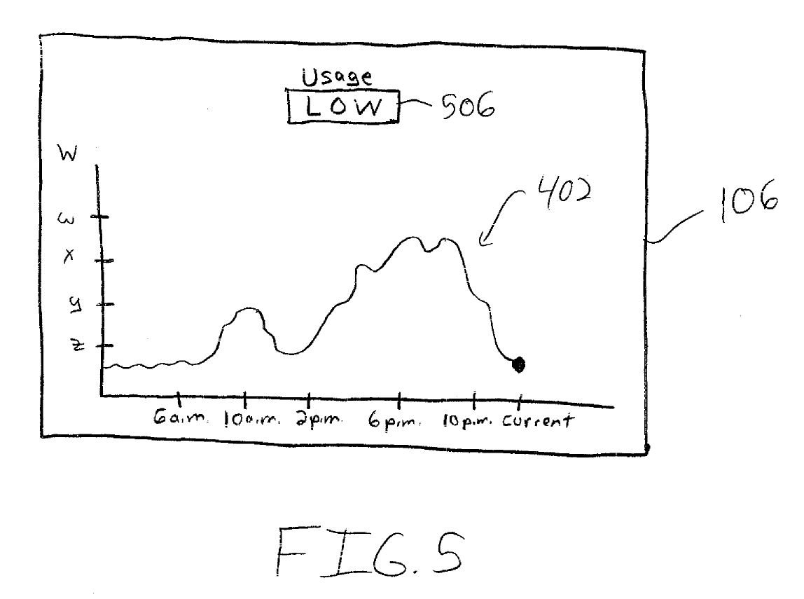

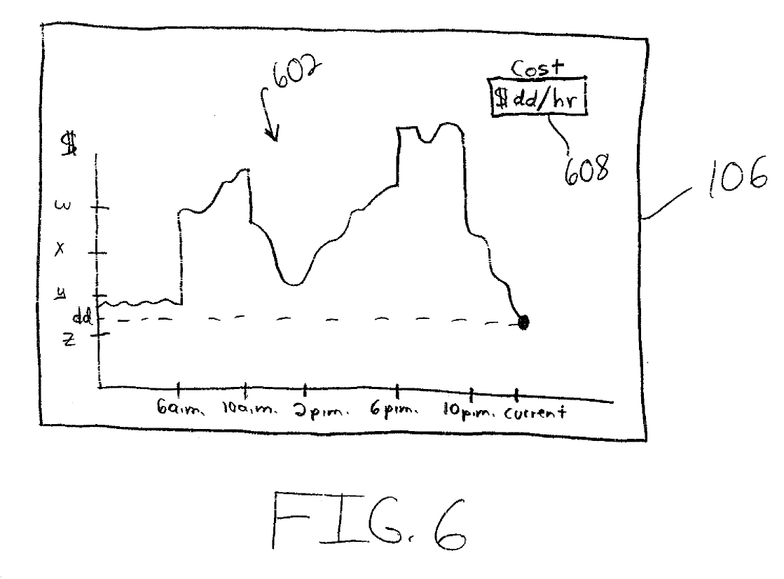

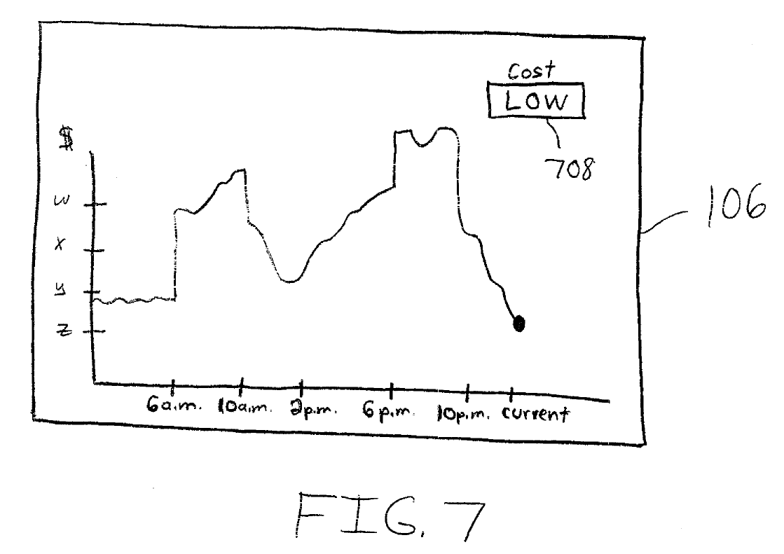

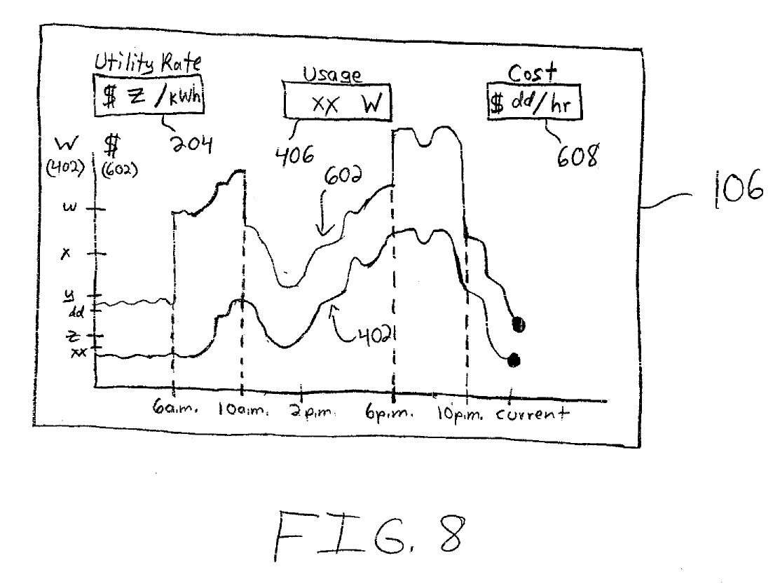

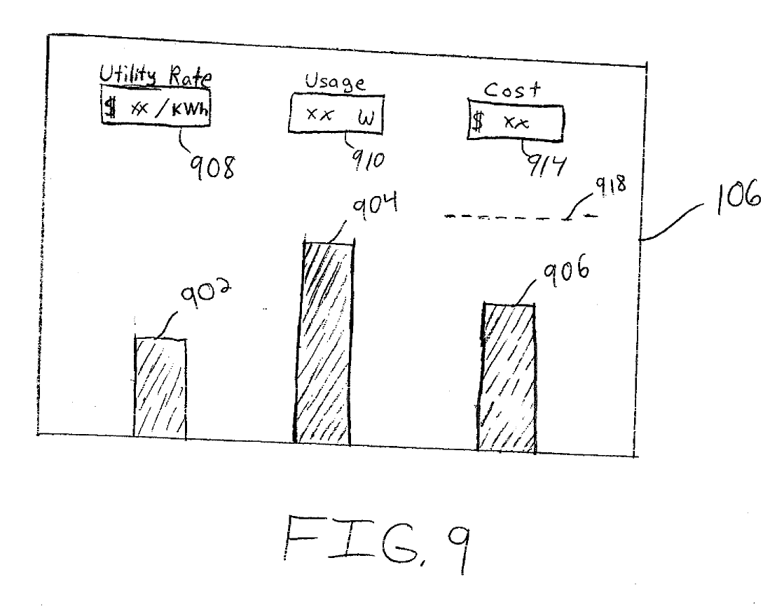

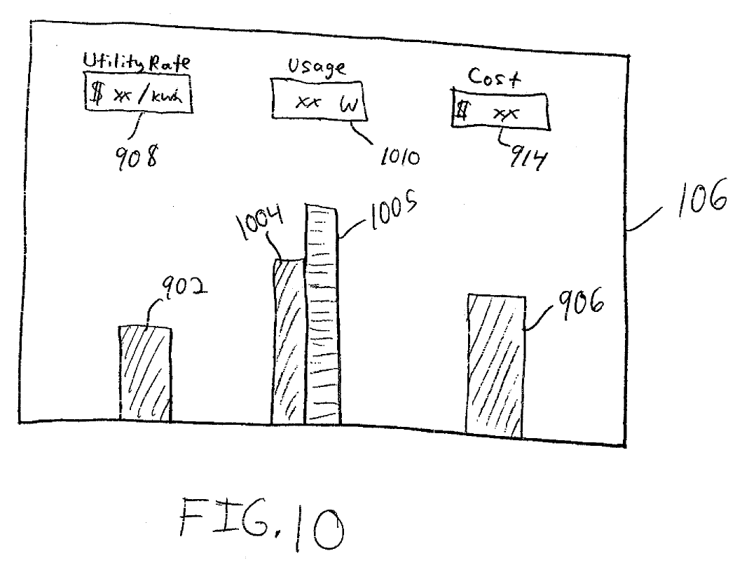

FIG. 1 is a simplified illustration of a usage display device 102 that is used for providing an electricity customer (e.g., a residential consumer of electricity), for example, electricity usage and pricing information in accordance with various embodiments of the present invention. According to various embodiments, device 102 may be wall mountable. In this case, device 102 will generally include one or more hooks, or other attachment components, on its back side.

As shown, device 102 includes an LCD 106 and a plurality of front mounted push buttons 108 in control section 110 for controlling the various features of device 102. As explained in greater detail below, buttons 108 may be used to control the reporting of, for example, real-time electricity usage (load) information, pricing (rates), current and running costs (where cost is calculated by multiplying usage and pricing) associated with the usage of electricity at a particular price, and past rate information on LCD 106. A side-mounted control wheel 114 also provides control of device 102 (and what is displayed on LCD 106) by providing push button (selection) and menu scrolling functionality.

According to various embodiments of the invention, such as the one shown in FIG. 1, device 102 also includes a power button 118 that can be used to turn device 102 (or just LCD 106) ON and OFF, or to put device 102 (or just LCD 106) into a power saving mode. Device 102 (or LCD 106) may also enter the power saving mode after a certain period of time has passed since one of buttons 108 or wheel 114 has been used. Once in power saving mode (or OFF), device 102 or LCD 106 can be activated (or turned ON) using either power button 118, one of the buttons of control section 110, or wheel 114, for example. When in active mode (e.g., when information is being displayed on LCD 106), an “ACTIVE” indicator 120 may be displayed to the customer.

Device 102 has one or more inputs for receiving information to be processed (e.g., by one or more internal processors, not shown) and/or displayed (e.g., using LCD 106). For example, as shown in FIG. 1, a built in WiFi or wireless network module 122 with an antenna which may receive FM Radio Broadcast Digital System RBDS signal 126 can be used to allow for connectivity of device 102 to a wireless network. Device 102 may also include an RJ45 Ethernet jack 130 for providing a connection to a network, or a traditional phone jack 134 for providing dial-up capability. A communications cable connection 138 may also be used. Moreover, although not shown, device 102 may, in place of or in combination with one or more of the above-described connection types, include serial connectivity (RD48.51232) and/or a powerline network connection. The above-described types of connections, or other suitable types of connection, can be used in isolation or in combination to gather rate information (e.g., pricing information) from the utility company that is providing electricity, as well as to gather usage information, for example, from one or more electricity meters. These connections may also be used, for example, to log into a database containing the latest rates being offered by the utility company serving the customer.

As shown in FIG. 1, device 102 may also include built in storage in the form of two removable Compact Flash cards 142 and 146. For example, Compact Flash card 142 may store the operating system for device 102, historical rate information, and real-time data collected from one or more electricity meters. Compact Flash card 146, on the other hand, may be used to upload rate information sent from utilities (e.g., when updated rates are not being received using one or more of the connections described above), as well as system updates sent from the manufacturer of device 102, for example. It will be understood that, although the use of Compact Flash cards 142 and 146 is shown in FIG. 1, the invention is not limited in this manner. For example, one or more Smart Media cards, a removable hard drive, or any other suitable type of storage may be used in connection with the principles of the present invention.

In the upper region of the front side of device 102, indicators 150 and 154 may be used to help a user of device 102 differential between current and historical information being displayed on LCD 106. Moreover, as shown in FIG. 1, a multicolor LED light 158 may also be included in this same region (or another region) of device 102. LED light 158 may be capable of lighting red or green only, or, in alternative embodiments, it may be capable of lighting red, yellow, and green, for example. As explained in greater detail below, LED light 158 can be used as an indicator regarding the current electricity pricing level (e.g., when “Rate” button 162 has been pressed), current electricity usage level (e.g., when “Usage” button 166 has been pressed), or current electricity cost level (e.g., when “Cost” button 170 has been pressed).

As shown in FIG. 1, device 102 may also include audible indicator 174. As explained in greater detail below, audible indicator 174 can serve several purposes. For example, device 102 can be configured using one or more of the buttons of control section 110, or wheel 114, to provide an audible indication when a certain usage (load) or pricing level has been surpassed, or during transitions between different pricing levels. Additionally, for example, audible indicator 174 may be used to provide an audible indication anytime that the color lighting of LED light 158 changes, anytime the color lighting of LED light 158 becomes red, and so on.

As will now be explained in greater detail, LCD 106 can be used to provide various types of information, and in various different forms, to a user of device 102. Although various information may be provided in isolation, as will be apparent from the following description, it will be understood by persons versed in the art that several benefits are obtained by displaying different information (e.g., pricing and usage information) simultaneously to a user of device 102. For example, by displaying current pricing information next to current usage information and cost information (such as shown in FIG. 9), a user of device 102 is better able to make an informed decision regarding whether to modify his electricity usage.

FIG. 2 shows a more detailed view of LCD 106 when device 102 is configured to display current (and recent) electricity pricing information using graph 202. While graph 202 displays pricing information for approximately an entire day, it will be understood that such information may be provided for a smaller or larger time frame. In addition to graph 202, as shown in FIG. 2, LCD 106 may also provide a digital reading of the current pricing of electricity using display portion 204 (e.g., in u.s. dollars, or cents, per Kilo Watt hour). In the LCD 106 view shown in FIG. 3, instead of providing a digital reading of the actual current pricing (as was the case in connection with FIG. 2), display portion 304 is used to indicate the general pricing level (e.g., off-peak, mid-peak, peak, etc). The names and price ranges for the various pricing levels may be set by the utility company, or, for example, by the user of device 102.

FIG. 4 shows a more detailed view of LCD 106 when device 102 is configured to display current (and recent) electricity usage information using graph 402. Display portion 406, on the other hand, provides a digital reading of the current electricity usage by the customer (e.g., in Watts). As shown in FIG. 5, display portion 406 may alternatively display the current electricity usage by the customer as one of “LOW,” “HIGH,” etc as defined by the utility company, or, for example, the user of device 102.

FIG. 6 shows a more detailed view of LCD 106 when device 102 is configured to display the current (and recent) cost of electricity usage (as determined by multiplying the current utility rate by the current electricity usage) using graph 602. Display portion 608, on the other hand, provides a digital reading of the cost (e.g., in U.S. dollars, or cents, per hour) of electricity usage based on current pricing and usage information. As shown in FIG. 7, LCD 106 may also indicate the current cost of electricity usage in display portion 708 as “LOW,” “HIGH,” etc. as defined by the utility company, or, for example, the user of device 102. Moreover, although not shown, display portion 102 can also be used to display the running (accumulated) cost of electricity usage over the time period shown in graph 602.

According to the present invention, some or all of the information discussed immediately above may be provided to the customer simultaneously on LCD 106 to help a user of device 102 be better able to make an informed decision regarding whether to modify his electricity usage. For example, as shown in FIG. 8, LCD 106 may simultaneously provide information relating to the current electricity pricing using display portion 204, information relating to electricity usage by the customer using graph 402 and display portion 406, and information relating to the cost of electricity usage using graph 602 and display portion 608. Among other things, LCD 106 shown in FIG. 8 provides the customer with a clear indication of the manner in which the current pricing of electricity affects the overall cost of electricity usage.

According to various embodiments of the present invention, LCD 106 may be used to provide the user of device 102 real-time (but not past) information relating to one or more of electricity pricing, electricity usage, and cost of electricity usage. For example, as shown in FIG. 9, LCD 106 may include bar graphs 902, 904, and 906 for presenting the customer with a clear visual indication of the relative pricing (rate) of electricity, usage of electricity, and cost of electricity usage at the present time. In addition, display portions 908, 910, and 914 may also be used present such information to the customer.

As shown in FIG. 9, device 102 can be configured to recognize a cost threshold level 918, which may be either hidden or visually displayed to the customer by LCD 918. In this case, when the current cost of electricity usage rises above this threshold level 918, device 102 may take one or more actions. For example, device may provide an audible signal to customer using audible indicator 174 to indicate that the cost threshold level has been surpassed. According to other embodiments, for example, LED light 158 shown in FIG. 1 may produce a red light to indicate to the customer that the cost threshold level has been surpassed. According to other embodiments, when similar thresholds are in place for the utility rate and the electricity usage, it will be understood that similar and other suitable responses may be taken.

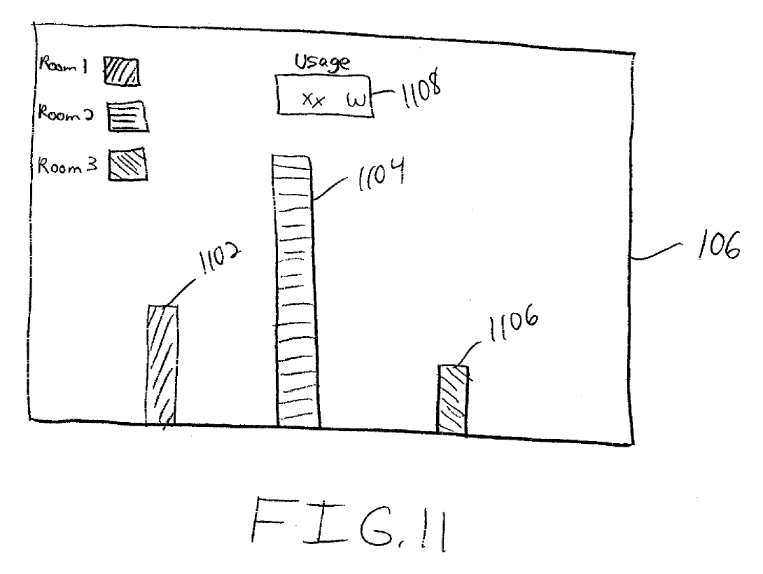

As shown in FIG. 10, LCD 106 can also be used to provide information to a customer relating to two or more separately measured loads. In other words, for example, bar graph 1004 may be used to provide the customer with information relating to the real-time electricity usage on a first floor of the property being monitored by device 102, while bar graph 1005 provides information relating to the second floor of the property. In this case, display portion 1010 may indicate the average of the two loads represented by bar graphs 1004 and 1005, alternate between the two loads, or simply indicate the usage level associated with one of the two loads. It will be understood that, in the case where multiple usage bar graphs 1004 and 1005 are being shown, either a single combined (averaged) cost bar graph 906 may be used (as shown in FIG. 10), or two bar graphs may be used corresponding to bar graphs 1004 and 1005.

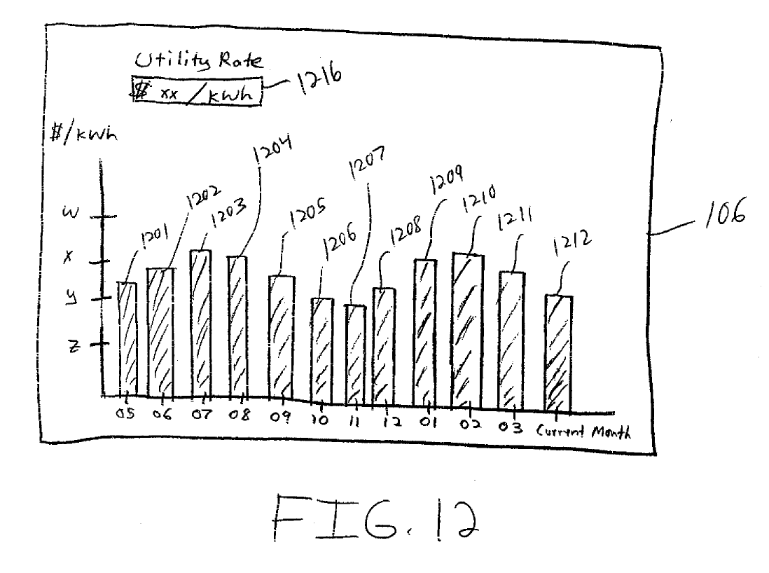

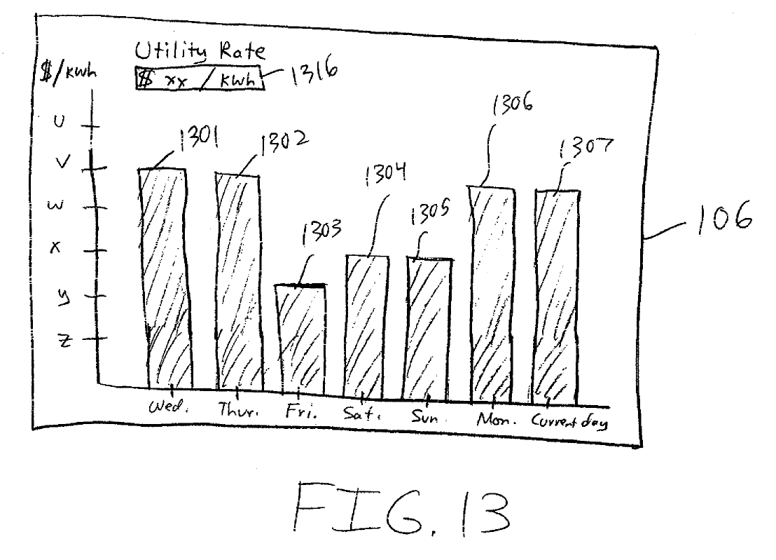

Moreover, the user of device 102 may request further information in connection with one or both of bar graphs 1004 and 1005 shown in FIG. 10, for example, by pressing on one of these bar graphs being displayed on LCD 106 (when it is touch sensitive), or using one or more of buttons 108 in control portion 110 or wheel 114. In this case, as shown in FIG. 11, LCD may use bar graphs 1102, 1104, and 1106 to provide electricity usage information on a room by room basis, for example, corresponding to the load represented by the selected bar graphs 1004 or 1005 of FIG. 10. Display portion 11 08, on the other hand, may display the average usage of the rooms corresponding to bar graphs 1102, 1004, and 1106, alternate usage information between the different rooms, and so on. Additionally, although not shown, bar graphs representing the cost associated with the electricity usage in these rooms may also be included on LCD 106. It should be noted that, when detailed information such as shown in FIGS. 10 and 11 is desired, the use of multiple electricity meters will generally be required.

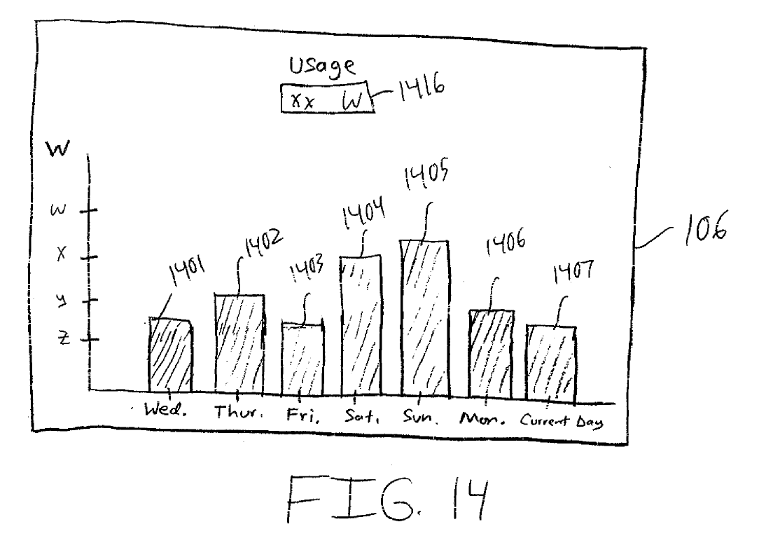

As with the line graphs shown in FIGS. 2-8, bar graphs such as shown in FIGS. 9-11 can also be used to provide information to the customer regarding past pricing, usage, and/or cost information. For example, FIG. 12 shows one way in which LCD 106 may use bar graphs 1201-1212 to display pricing information for the past twelve calendar months (where each bar graph represents the average pricing for a particular month). Additionally, as shown, display portion 1216 can be used to show, for example, the average pricing for electricity over the past twelve months. Alternatively, for example, the user of device 102 may select a particular month for which to display pricing information in display portion 1216. Moreover, the customer may select other prior months, or other time frames, for which to display information.

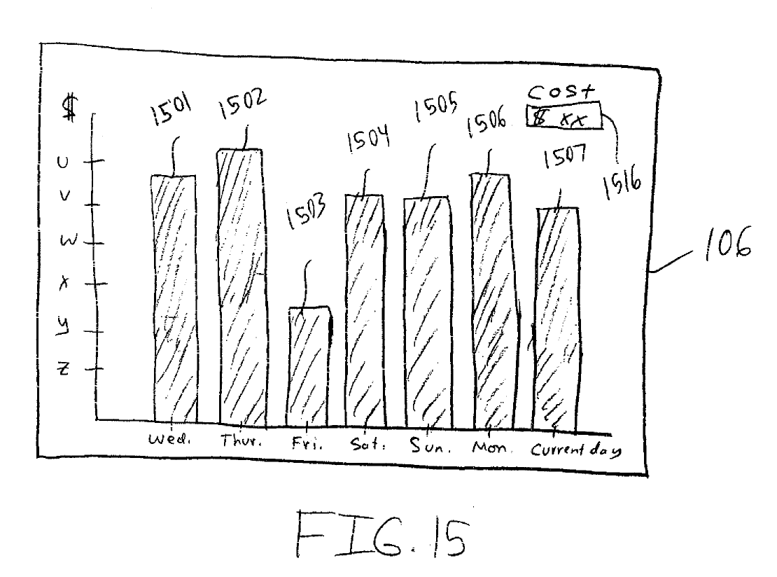

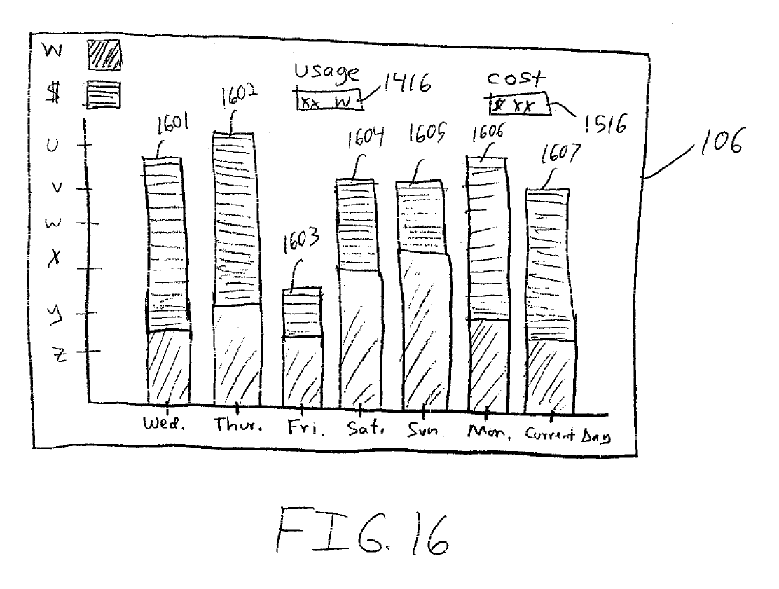

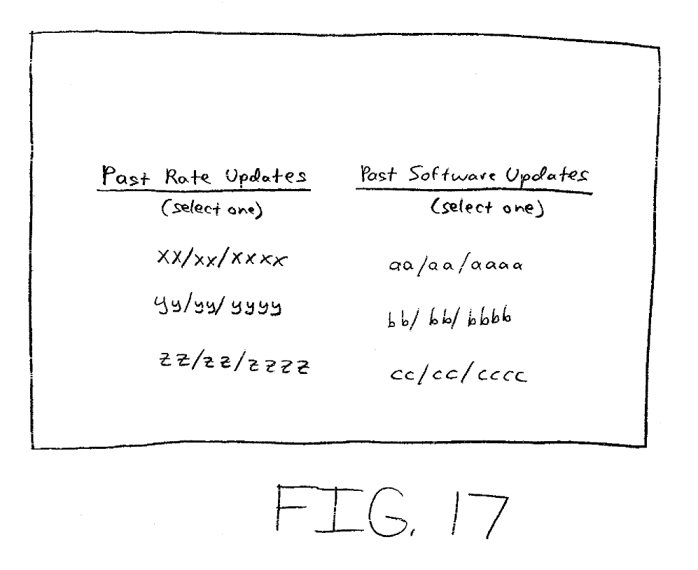

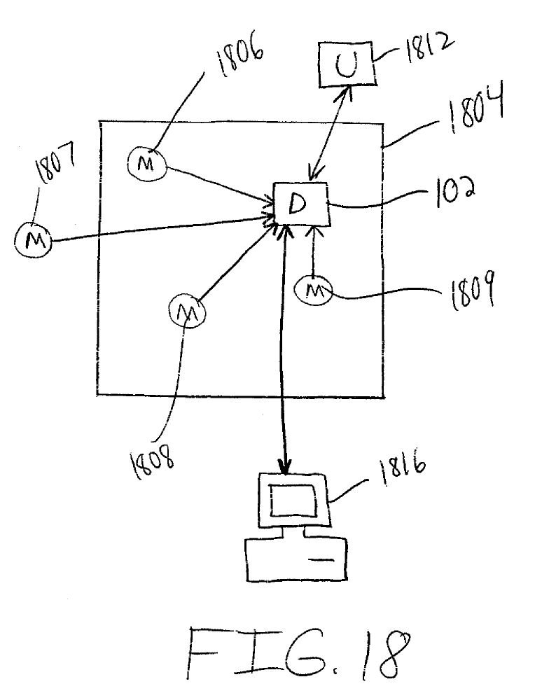

In FIG. 13, LCD 106 provides electricity pricing information to the user of device 102 for the current week using bar graphs 1301-1307. Additionally, display portion 1316 can be used to show, for example, the average rate (price) for electricity over the past week. Alternatively, for example, the customer using device 102 may select a particular day for which to display the rate information in display portion 1316. For the same week being considered in connection with FIG. 13, FIG. 14 shows usage information using bar graphs 1401-1407 and display portion 1416 to the user of device 102. Moreover, in FIG. 15, LCD 106 shows cost information relating to the usage of electricity in the current week using bar graphs 1501-1507 and display portion 1516. In FIG. 16, on the other hand, LCD 106 shows bar graphs 1601-1607 in which the usage information and cost information shown in FIGS. 14-15 have been combined to provide the customer with both types of information in a single screen.

FIG. 17 shows LCD 17 when device 102 is in a historical analysis mode. At this time, for example, “HISTORICAL” indicator 154 may be visible to indicate the current mode of device 102. As shown, when in the historical analysis mode, the customer is able to select various information for viewing relating to past rate updates and past software updates to device 102. For example, upon selection of date “yy/yy/yyyy,” the user of device 102 is presented with information relating to rate changes that took effect on that date. On the other hand, upon selection of date “cc/cc/cccc,” for example, the customer is presented with information relating to any software upgrades or other changes that were made to device 102 on this date.

FIG. 18 shows a monitoring region 1804 fat which device 102 is being used to provide information. For example, monitoring legion 1804 may include a house, a house and adjacent property (e.g., a garage), a commercial warehouse, or any other suitable type of region that device 102 may be used in connection with. As also shown in FIG. 18, a plurality of electricity meters 1806-1809 are used to provide the necessary usage information to device 102. Although a particular number of meters 1806-1809 are shown, it will be understood that the invention is not limited in this manner. In particular, as few as one to three meters, or more than four meters, may be used in accordance with the principles of the present invention. Moreover, as explained above, device 102 receives rate information either directly, or indirectly, from utility 1812 using one or more modes of communication

As also shown in FIG. 18, remote access to device 102 may be achieved using, for example, computer 1816 Device 102 and computer 1816 may communicate, for example, using the FM Radio Broadcast Digital System RBDS, Internet, a wireless connection, or any other suitable means of communication. Moreover, while a computer 1816 is shows as being used for remote access to device 102, it will be understood that a personal digital assistant (PDA) or other suitable device may also be used for this purpose. In addition, although computer 1816 is shown in FIG. 18 as being outside the boundaries of monitoring region 1804, it will be understood that the invention is not limited in this manner. For example, computer 1816 may be in a different room than device 102, but still within monitoring region 1804. The invention is not limited in this manner.

Although the invention has been described and illustrated in the foregoing illustrative embodiments, it is understood that the present disclosure has been made only by way of example, and that numerous changes in the details of implementation of the invention can be made without departing from the spirit and scope of the invention. For example, device 102 may be easily modified such that a user of device 102 is capable of controlling the electricity usage by one or more devices, locations (e.g., rooms), and so on. Similarly, device 102 may be programmed by a user to automatically adjust electricity usage (load conditions) based on predetermined parameters (e.g., to reduce the electricity usage by all air conditioners by 10% when the pricing for electricity rises by 15% of more).

It will also be understood that device 102 may use any suitable type of operating system and associated software to achieve the functionality described herein. Additionally, for example, although a single multicolor LED light 158 is shown in FIG. 1, the invention is not limited in this manner. Rather, according to various embodiments of the present invention, multiple LED lights similar to LED light 158 may be used. For example, in the case of two LED lights, one may be used to provide a color indication regarding the current pricing of electricity, while the second LED light provides a color indication regarding the current electricity usage. In this manner, a customer is able to easily identify when changes in electricity usage may be desirable (e.g., when both LED lights are red).

Moreover, it will be understood that, although the invention is described with particular attention to the pricing, usage, and cost of electricity, the invention is not limited in this manner. Rather, it will be understood that the principles of the present invention may be used in connection with other types of utilities. Accordingly, for example, a device similar to device 102 may be used to convey pricing, usage, and cost information relating to the use of natural gas, oil, water, and so on.

It will also be understood that, according to various embodiments of the present invention, the particular manner of providing certain information on LCD 106 may be varied. In particular, although line graphs and bar graphs have been described above and used in various figures, the invention is not limited in this manner. For example, dotted line graphs, graphs where the area below the curves are shaded, or other types of graphs may be used in presenting the different types of information described above on LCD 106. Additionally, while a single LCD 106 has been referenced above and is shown in FIG. 1, it will be understood that the various graphs described above and similar graphs may be provided on multiple LCDs.

One of the key parts of the Powerbox system is the ability to display to consumers real time cost information for their electric usage. Real time rate information is publicly available via the internet, but due to the questionable availability of a wifi connection or other systems in a consumer's household, another method of data transmission to the Powerbox was sought. Conventional radio is used as the means of transmitting real time pricing information due to the low cost of transmission and the universal penetration of analog radio in the United States.

The Radio Broadcast Data System (RBDS) was created in 1998 based on an earlier European standard, RDS, RBDS and RDS are essentially identical, and the two terms used interchangeably in this document. The purpose of RBDS is to enable the transmission of digital data over an analog radio broadcast; specifically, RBDS embeds a data stream at 57 khz in a conventional radio transmission. This enables concurrent broadcasting of regular analog audio in the audible band (approximately 60 hz to 20 khz) along with the embedded digital broadcast.

In the United States, RBDS is primarily used for a system called Radiotext, which enables RBDS equipped radio receivers to display song title and artist information on an LCD display, concurrent with the audio transmission of that song. RBDS is utilized in this invention as a foundation for generic data transport format. Due to various reasons, such as the limited bandwidth available in an RBDS transmission, such wider uses have not been employed in the United States. The present invention overcomes such prior art limitations.

A feature of RBDS used in this invention is a generic data transport protocol, called Open Data Application, or ODA. ODA is used to permit RBDS to allow for arbitrary data transmissions ODA is used to transmit all of the data for use by the Power Box.

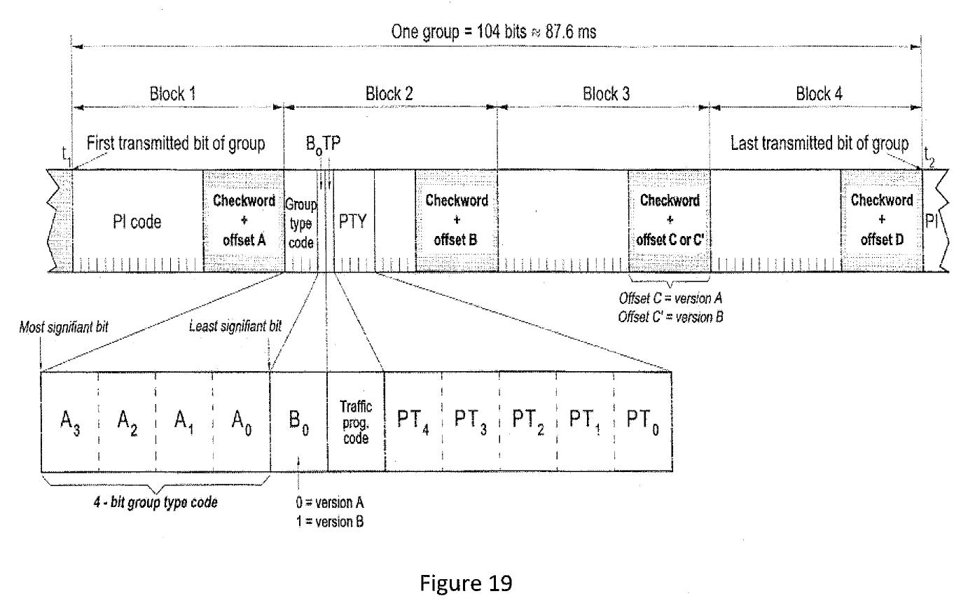

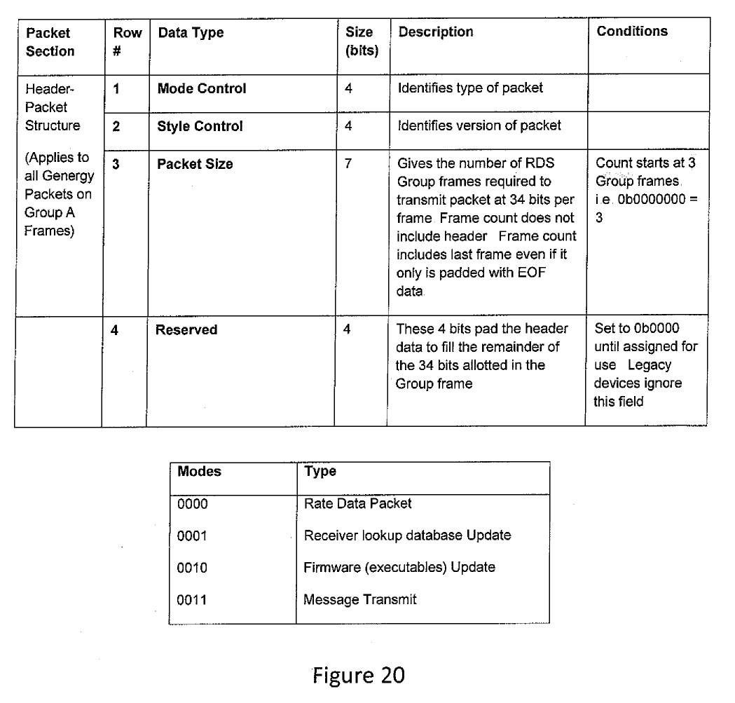

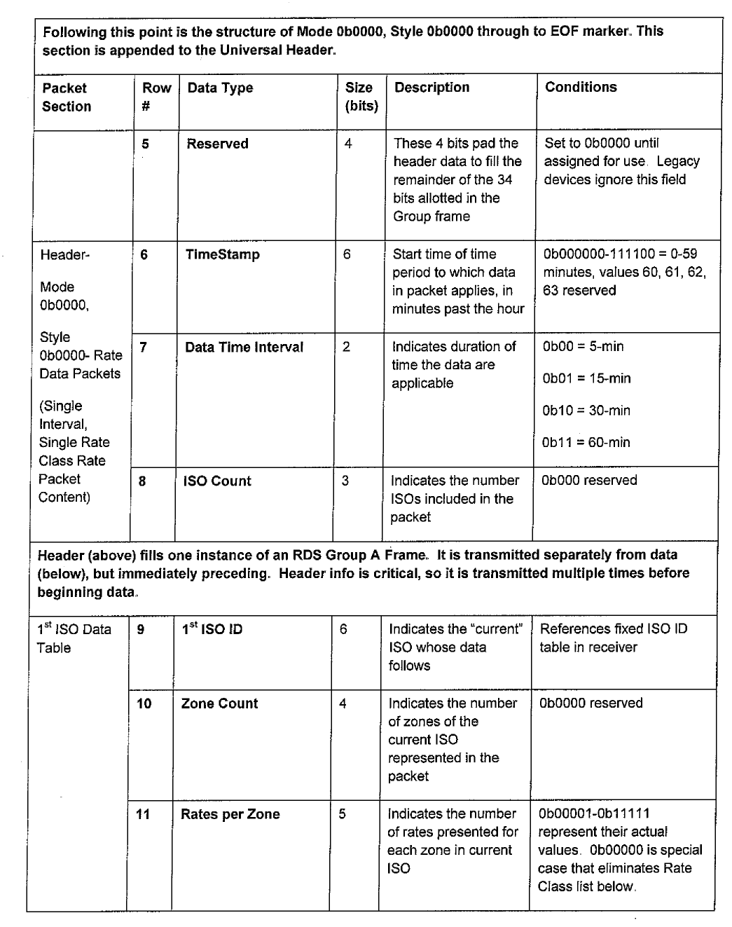

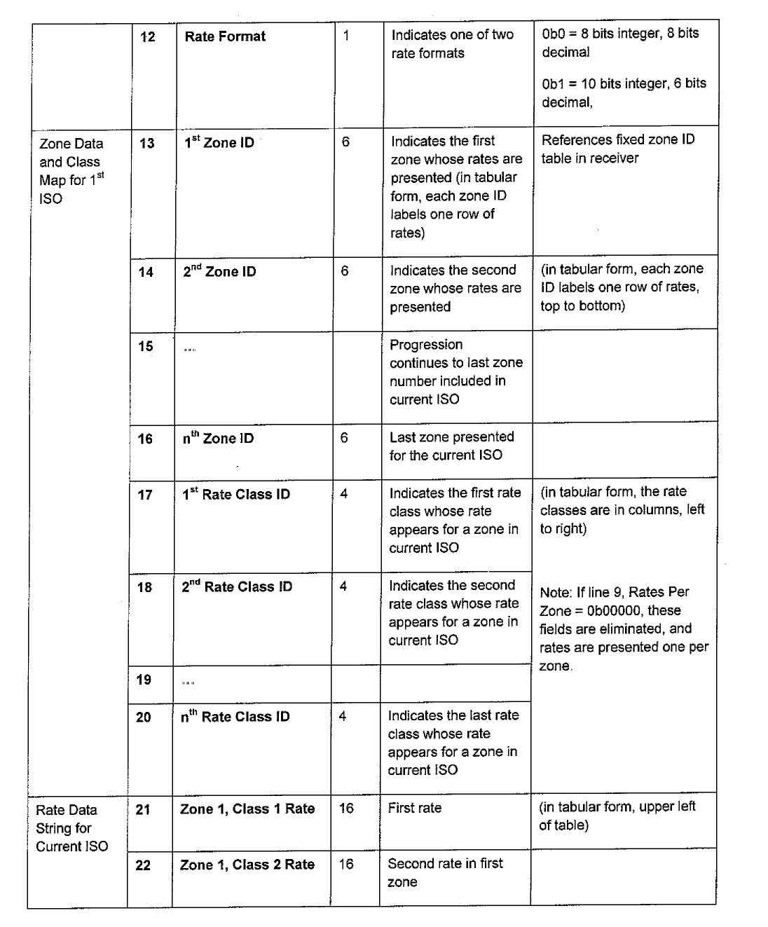

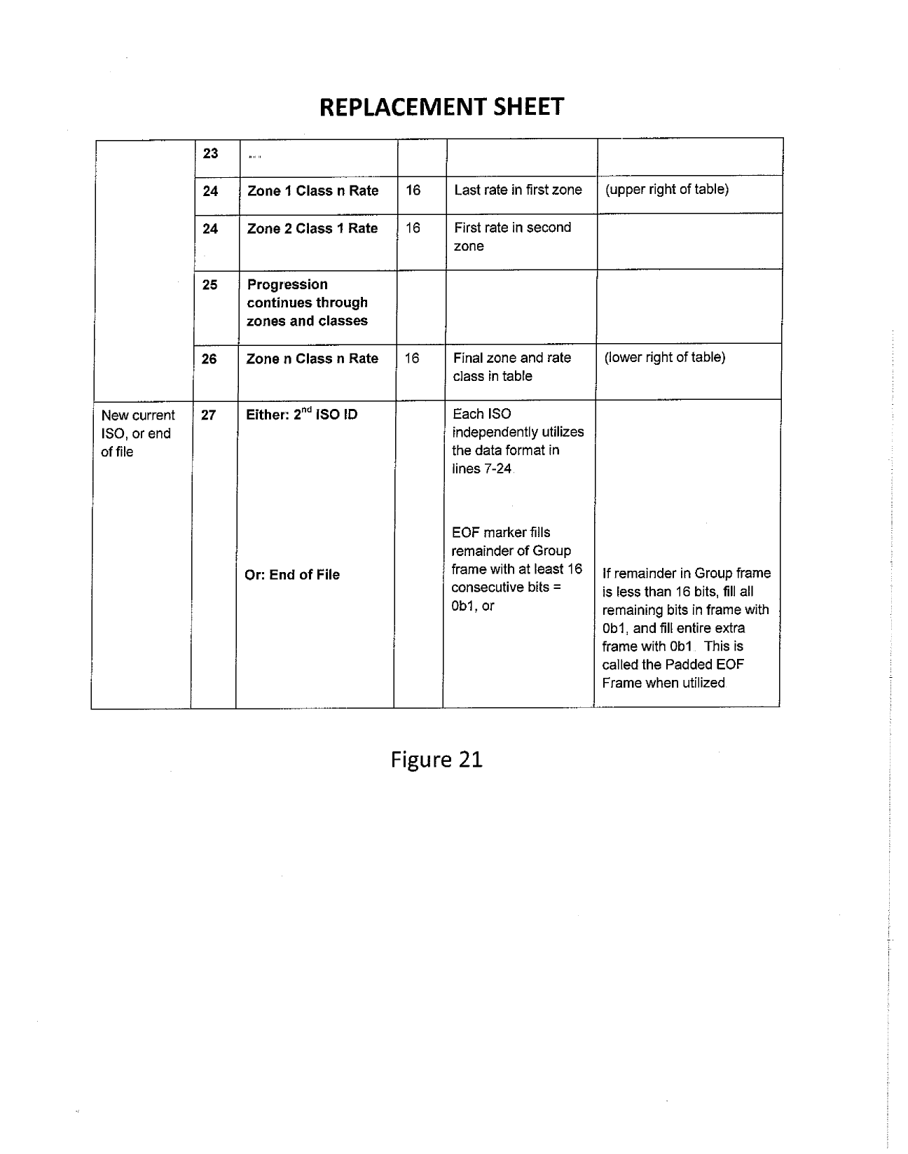

FIG. 19 displays the basic format of an RBDS message packet or group. ODA uses this packet to enable data transmission; specifically, the 16 bits of Blocks 3 and 4, as well as the last 5 bits of Block 2, is used for arbitrary data transmission, for a total of 37 bits of data per RBDS group. This invention creates a packet specification utilizing those 37 bits to enable arbitrary data transmission to the Powerbox. This specification includes a generic header packet (FIG. 20) and a general data transmission packet for rate data (FIG. 21). Between these two packets, the present system successfully leverages ODA to transmit real time rate and pricing information to the Powerboxes in the field.

The present system is designed to allow for multiple modes of data transmission, as shown in FIG. 20: the basic function is the transmission of real time rate information to the powerbox, but additional uses for ODA includes, such as the ability to transmit firmware updates to the unit, to transmit updates to the static data on the power box, or the ability to display real time messages to users. Due to the flexibility of the header of this invention, the system is extensible to any sort of future utilization of other data transmission

The ODA may include information directed to specific neighborhoods, specific demographic data, even to specific Power Boxes. Packets of information transmitted over the FM system could include zip codes so that only Power Boxes in specific zip code areas would receive specific packets of information. The rate supplied throughout the legion supplied by an FM transmitter could include a plurality of different rates over different times, so that the rate information is transmitted as specifically directed by the charging authority which then becomes localized to different areas in which the general FM signal is broadcast.

The Power Box is designed so that microchips may be interchanged such as by using flash cards so that the programs run by Power Boxes could be changed by a homeowner. The local energy provider may have contests in which certain groups of people were awarded benefits for better energy performance, after which, those who are successful receive new microchips to provide different data processing controls thereby producing different rate charges rewarding those who consume less energy by reducing their energy costs.

Utilization of the ODA in the REDS provides a unique and targeted advantage for localized energy control and consumption which provides such specific targeting by utilization of ODA information. The ability to integrate such ODA into conventional wireless FM radio transmission with its easy reach of large scale populations is a significant benefit. The local power authority provides its information to the system of the present invention, and such information will then be transmitted through the present invention to the FM system so that it becomes part of the ODA to be targeted where appropriate according to whatever codes are required so as to localize the ODA transmission and transmit the required power information to localized users and their Power Boxes. By utilizing an FM system, the simplicity with which such systems operate and the ease with which ordinary consumers can adapt such Power Boxes within their homes is understood. It is as simple as turning on your radio and watching the display in order to determine the information one seeks to determine current energy usage within the house on a real-time basis

Therefore, other embodiments, extensions, and modifications of the ideas presented above are comprehended and should be within the reach of one versed in the art upon reviewing the present disclosure. Accordingly, the scope of the present invention in its various aspects should not be limited by the examples presented above. The individual aspects of the present invention, and the entirety of the invention, should be regarded so as to allow for such design modifications and future developments within the scope of the present disclosure. The present invention is limited only by the claims which follow.

What is claimed is:

1. A method for providing electricity usage and pricing information at a consumer's location, comprising: receiving electricity usage data at a display device; displaying, using the received usage data, electricity usage information by the display device for identifying real-time usage of electricity; receiving electricity pricing data at the display device; displaying, using the received pricing data, electricity pricing information by the display device for identifying real-time pricing of electricity, and transmitting the electricity pricing information using FM Radio Broadcast Digital System directly to the consumer location.

2. The method of claim 1, wherein the electricity usage information is received from one or more electricity meters.

3. The method of claim 1, wherein the electricity pricing information is received from an electricity provider.

4. The method of claim 1, wherein the displaying electricity usage information by the display device comprises displaying a graph showing real-time usage of electricity.

5. The method of claim 1, wherein the displaying electricity usage information by the display device comprises displaying a measurement of the current usage of electricity.

6. The method of claim 1, Wherein the displaying electricity usage information by the display device comprises producing light of different colors.

7. The method of claim 1, wherein the displaying electricity usage information by the display device comprises producing light having one of three colors.

8. The method of claim 1, wherein the displaying electricity pricing information by the display device comprises displaying a graph showing real-time pricing of electricity.

9. The method of claim 1, wherein the displaying electricity pricing information by the display device comprises displaying a measurement of the current pricing of electricity

10. The method of claim 1, further comprising determining real-time cost in connection with the received usage data and pricing data; and displaying, using the determined real-time cost, electricity cost information by the display device.

11. The method of claim 10, wherein the displaying electricity cost information by the display device comprises displaying a graph.

12. A system for providing electricity usage and pricing information at a consumer's location, comprising: at least one electricity meter capable of measuring and storing information relating to the usage of electricity; and a display device for displaying both electricity usage information for identifying real-time usage of electricity and electricity pricing information for identifying real-time pricing of electricity, wherein the displayed electricity usage information is based on received electricity usage data and the displayed electricity pricing information is based on received electricity pricing data, means using FM radio transmission and RBDS message format to transmit electricity real-time pricing information to said consumer location

13. The system of claim 17, wherein the display device also determines real-time cost in connection with the received usage data and pricing data, and displays electricity cost information based on the determined real-time cost.

14. The system of claim 12, wherein said RBDS is transmitted from an FM radio transmitter and comprises a generic data transport protocol.

15. The system of claim 14, wherein said generic data transport protocol comprises Open Data Application comprising a plurality of bits per data per REDS group.

16. The system of claim 14, wherein multiple modes of data transmission are provided.

17. The system of claim 16, wherein said multiple modes are selected form a group comprising firmware updates, updates to static data at the consumer location and real time messages.

18. The system of claim 16, wherein said multiple modes are selected from the group comprising specific neighborhoods, specific consumer demographics, zip codes and exact address and location data of the consumer.

19. The system of claim 12, wherein said consumer location comprises a system box receiving and displaying said information and means to interchange microchips therein to alter the system operation of said system box.
